(19) United States
(12) Patent Application Publication
(10) Pub. No.: US 2014/0006060 A1
(43) Pub. Date: Jan. 2, 2014

(54) SYSTEM AND METHOD FOR PROCESSING DATA RELATED TO WORKSITE ANALYSES

(71) Applicants: Judith P. Sehnal, Wolcott, CT (US); Margaret E. Walsh, Plainville, CT (US)

(72) Inventors: Judith P. Sehnal, Wolcott, CT (US); Margaret E. Walsh, Plainville, CT (US)

(73) Assignee: Hartford Fire Insurance Company, Hartford, CT (US)

(21) Appl. No.: 13/535,163

(22) Filed: Jun. 27, 2012

(51) Int. Cl. G06Q 40/08

(52) U.S. Cl. 705/4

(57) ABSTRACT

A computer system for processing data related to loss control associated with worksites, includes a loss control hardware server, configured to: receive data indicative of worksite conditions from a portable user-accessible device; access from a data storage device stored business logic data relating to worksite condition analysis; and process the data indicative of worksite conditions in accordance with the accessed business logic data to generate workplace analysis data relating to the worksite of the employer. The system further includes an employer communications interface device configured to receive the workplace analysis data from the loss control hardware server and generate an employer communication incorporating the workplace analysis data.

### FIELD OF INVENTION

The present invention relates to computer systems, and particularly to computer systems for use in the insurance field.

### BACKGROUND

Group benefits insurance is provided by insurance companies to employers to provide benefits in the event of certain losses occurring to employees. By way of example, group benefits may include the general categories of group disability, life and accident insurance, and voluntary benefits.

Group disability typically includes short-term disability coverage, long-term disability coverage, and statutory disability coverage. Short-term disability coverage typically provides periodic payments that replace a portion of the customary salary and wages of an employee, upon approval of a claim showing that the employee is unable to perform his or her customary employment duties. In short-term, long-term and statutory disability coverage, in contrast with workers compensation coverage, the cause of the disability need not be related to employment. Thus, disabilities resulting from any activity, on or off the job, can result in an employee qualifying for disability benefits. Short-term disability generally provides coverage for injuries and conditions that prevent the employee from performing his or her customary employment duties. The benefit for a short-term disability claim is typically a periodic payment determined as a percentage of the customary wages or salary of the employee. Short-term disability benefits are typically available for disabilities that persist after expiration of a waiting period of 7 to 14 days, for example, and continue for a maximum term of typically about 180 days.

Long-term disability benefits are similar to short-term disability benefits, but are for disabilities that persist for a period of time of more than a waiting period of, for example, 180 days, and continues for a maximum benefit term of, for example, 24 months. Statutory disability benefits are required in certain states, in addition to short term and long term disability.

Life and accident insurance includes group term life insurance, which provides for a death benefit upon death of an insured employee during the term of the policy, which may be a term of employment or a term of years. Accident insurance provides benefits based upon varying factors resulting from an accidental injury or accidental death, such as fixed payments for hospitalization, loss of limbs, and the like, or a death benefit paid on condition of death caused by accident.

Costs associated with group benefits policy include costs of premiums paid by an employer. Premium rates are based on a variety of factors, including past claims history of the employer.

In addition to costs of claims and premiums related to group benefits policies, injuries to employees result in lost productivity and it is therefore desirable to avoid injuries and to mitigate the effects of injuries on productivity.

Systems and methods that reduce the cost of injuries, including reducing the cost of claims and thereby reducing the cost of group benefits insurance to employers, would be desirable.

### SUMMARY

In an embodiment, a computer system for processing data related to loss control associated with worksites includes a loss control hardware server and an employer communications interface device. The loss control hardware server is configured to: receive data indicative of worksite conditions from a portable user-accessible device; access from a data storage device stored business logic data relating to worksite condition analysis; and process the data indicative of worksite conditions in accordance with the accessed business logic data to generate workplace analysis data relating to the worksite of the employer. The employer communications interface device configured to receive the workplace analysis data from the loss control hardware server and generate an employer communication incorporating the workplace analysis data.

In an embodiment, a computer-implemented method for processing data relating to loss control associated with worksite conditions at locations of employers includes receiving, at a loss control system hardware server, from a portable user-accessible device, data indicative of worksite conditions at a worksite of one of the employers; accessing, by the loss control system hardware server, from a data storage device, stored business logic data relating to worksite condition analysis; processing, by the loss control hardware server, the data indicative of worksite conditions in accordance with the accessed business logic data, to generate workplace analysis data relating to the worksite of the employer; receiving by an employer communications interface device the generated workplace analysis data; and generating by the employer communications interface device an employer communication incorporating the workplace analysis data.

In an embodiment, a non-transitory computer-readable storage medium, the computer-readable storage medium having processor-executable instructions stored thereon relating to processing of data for worksite analysis, which instructions, when executed by the processor, cause the processor to: receive, from a portable user-accessible device, data indicative of worksite conditions at worksite of an employer; process the data indicative of worksite conditions in accordance with stored business logic data, to generate worksite analysis data relating to the worksite of the employer; and output the worksite analysis data to an employer communications interface device.

### BRIEF DESCRIPTION OF DRAWINGS

FIG. 1 is a schematic diagram showing an environment in which a computer system for providing loss control related data processing may be implemented.

FIG. 2 shows a system including a user device and associated screen display for use by an on-site evaluator in conducting an assessment in an implementation of a method and system of the invention.

FIG. 3 shows a system including a user device and associated screen display for use by an on-site evaluator in developing a functional job analysis in an implementation of a method and system of the invention.

FIG. 4 is a high-level diagram illustrating data flows in an implementation of a method and system of the invention.

FIG. 5 is a schematic diagram of an exemplary computer system and associated networked devices in an implementation of a method and system of the invention.

FIG. 6 is a diagram of an exemplary server computer and associated databases and networked devices in an implementation of a method and system of the invention.

FIG. 7 is a process flow diagram of data processing steps performed by a computer system in an embodiment of a system of the invention.

FIG. 8 is a process flow diagram of data processing steps performed by a computer system in an alternate embodiment of the invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for processing of data relating group benefits administration and other insurance programs. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

For insurers that provide group benefit insurance, injuries suffered anywhere that result in inability to perform employment duties, other serious injuries and loss of life, result in claims. Reduction of the rate of workplace injuries would accordingly reduce the number and possibly the severity of claims for benefits under group benefits policies.

An employee is deemed to met the requirements for short term or long term disability benefits if the employee is unable to perform his or her customary duties in the workplace. An employee may be able to perform the duties of an alternative position during a period of recovery. For example, an employee whose ordinary duties require lifting of objects of up to 50 pounds qualify for short-term disability benefits as a result of a back injury. That employee may be able to perform other duties not involving lifting of such large objects even during a period of recovery. In this situation, identification of transitional duties, such as alternative positions or modifications to job duties, may shorten the period of benefits under a disability claim, thereby reducing the cost of the claim to the insurance company.

In embodiments, a computerized system facilitates the collection of data relating to loss control at sites of employers. An insurance company administrative computer system associates an employer site with an on-site analyst. The on-site analyst employs a portable device, such as a laptop or table computer system, to record data at the employer site. The employer site may include any physical area where an employee performs employment tasks, and may range from a single workstation in an office or a single station along an assembly line to an entire manufacturing, distribution or other facility. The on-site analyst obtains data relating to loss control, which loss control data may include worker duties and activities, workplace materials and equipment and any other data affecting or potentially affecting likelihood of workplace injury. The portable device may be configured to create, tag and store digital still images, video and sound files of data relating to observed workplace conditions. The portable device may be configured to generate display documents to prompt the user for data relating to job duties, by way of example.

The data gathered at the on-site visit may be uploaded from the portable device to a loss control system server. The loss control system server may execute instructions to compare structured data in the data from the on-site analyst to rules accessed from a database or implemented in a process flow in computer program code.

The loss control system server may process data to determine workplace analysis data. The determined workplace analysis data may include loss control steps based on the data received as a result of the on-site analysis. The workplace analysis data may include recommended changes to workstation configuration, additional equipment, changes to process steps, changes in job duties, and other recommendations. The workplace analysis data may be configured in the form of a report in printed or electronic form furnished to the customer.

The workplace analysis data may further provide a functional job analysis. A functional job analysis may include data indicative of qualifications and duties for a job, including education, training, certification and experience prerequisites; descriptions of particular duties, including equipment used and/or operated by the employee; supervisory requirements; interactions with customers, vendors, and other employees including employees from other divisions or functional units of the companies; communications requirements, such as requirements to provide written reports, instructions or analyses and verbal requirements; breakdown of daily/weekly or other periodic duties by type of task, equipment operated, physical demands, such as standing, sitting, walking, lifting, reaching and details of such requirements; and physical hazards, such as locations involving harsh environmental conditions, e.g., high heat, particulates or gases in the air, and/or hazards associated with machinery and equipment. Output data associated with a functional job analysis may include a report provided in printed and/or electronic static or interactive form to an employer including data such as that described.

A functional job analysis has numerous uses, including its availability for analysis for modifications that can be made to reduce the risk of injury. A functional job analysis may also be employed in identifying modifications for transitional job duties when a recovering worker is returning to the workplace.

In an embodiment, an insurance company system server may be configured to generate data for instructions for a site visit responsive to data such as a request initiated by an employer representative or a request associated with a prospective or new customer for group benefits insurance. In such an embodiment, the instructions for a site visit may be generated independent of claims data. In another embodiment, the instructions for a site visit may be generated in response to a request by an employer representative in response to one or more claims, but independent of an analysis of claims data. In an embodiment, a request for a site visit to perform a functional job analysis may be generated by an employer request independent of claims data. The request for a site visit to perform a functional job analysis may further be generated by an employer who is a current customer for group benefits insurance, or may be generated by an employer who is not a current customer for group benefits insurance. In an embodiment, an employer may make available claims data under one or more group benefits policies issued by one or more different carriers; the insurance company system may analyze the claims data under such group benefits policies to identify candidates for site visits. The insurance company system may perform an analysis of claims data including claims data under one or more group benefits policies issued by other carriers and claims data under one or more policies of the insurance company. In an embodiment, an employer who is not a current customer for group benefits insurance may request a site visit for purposes including ergonomic analysis, by way of example. A request for a functional job analysis or an ergonomic review may further be generated in connection with an employer decision to identify transitional duty for one or more employees, such as an employee who has been receiving short term disability or long term disability benefits.

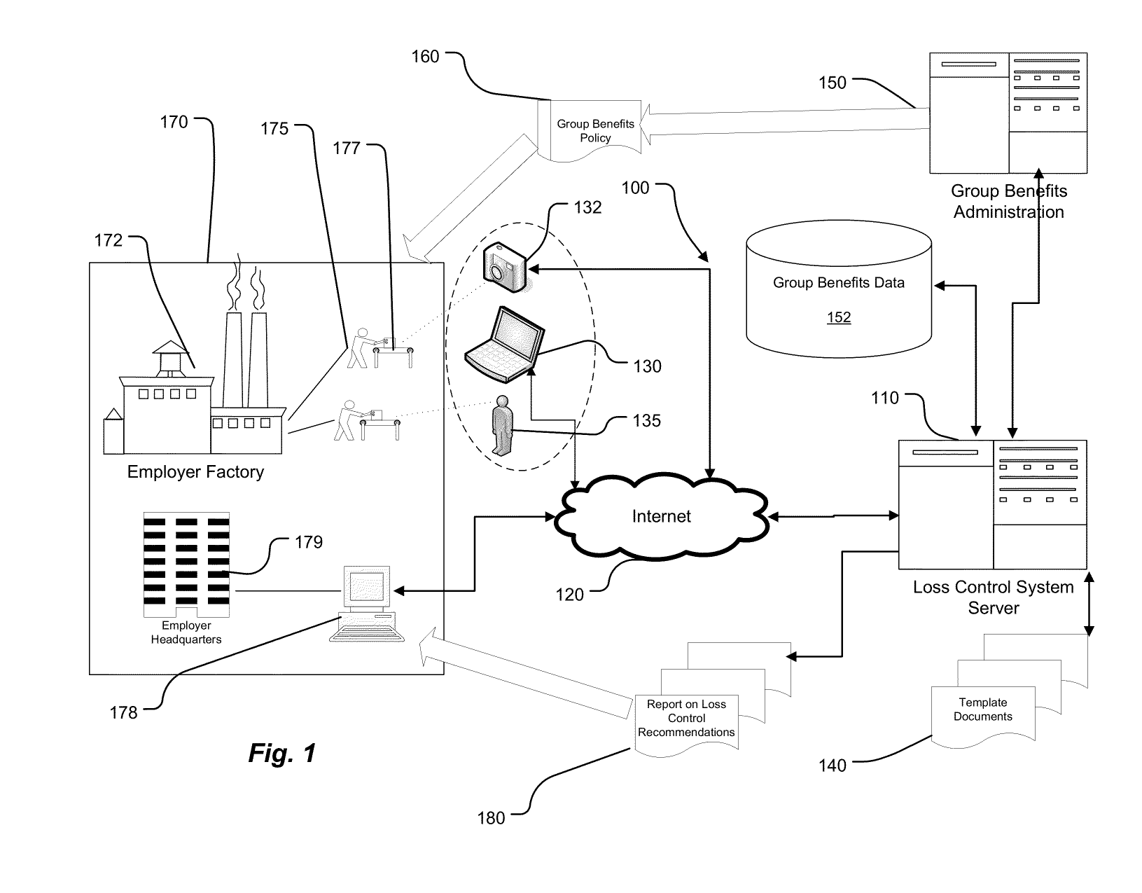

Referring now to FIG. 1, an exemplary system 100 for processing data related to loss control is shown. System 100 includes loss control system server 110, which may be in communication via an internal network, such as an insurance company intranet or local area network, with group benefits administration database 152. System 100 further includes portable user-accessible devices 130, 132, which are in communication with loss control system server 110 and are configured to receive data indicative of worksite conditions. An on-site analyst 135 may observer worksite conditions and operate portable user-accessible devices 130, 132, to collect data relating to worksite conditions. The portable user-accessible devices 130, 132 may include laptop computer 130 and digital camera 132, by way of example. Portable user-accessible devices 130, 132 are configured to provide data relating to worksite conditions to loss control system server 110.

Group benefits administration hardware server 150 is configured to process data relating to group benefits insurance coverage provided to employers. Group benefits administration hardware server 150 receives, processes and stores data relating to insurance such as short term and long term disability insurance, group term life insurance, and other group benefits insurance products and services. Group benefits administration hardware server 150 receives, processes and stores data including data relating to covered employers, including numbers, locations and job classifications of employees, group benefits products provided to or available for the employees, employer-specific coverage elections for selected products, premium formulas and premium amounts, and claims data, including claim identification data, status of claims, amounts paid, employee associated with the claim, and other data.

An insurance company that underwrites group benefits policies and is responsible for group benefits administration hardware server 150 has issued group benefits insurance policy 160 to employer 170. Employer 170 has a facility 172 including employees 175 working with equipment 177.

Loss control system server 110 is configured to access from group benefits administration database 152 data relating to group benefits insurance policies, including group benefits insurance policy 160 issued to employer 170. Loss control system server 110 is configured to process data relating to group benefits insurance policies to determine data relating to loss control services to be provided to employers, such as employer 170. The determination may include identification of employers selected to be notified of the availability of loss control services. The determination as to identification of employers selected to be notified of the availability of loss control services may include claims history of employers, claims histories of employer facilities, claims history of industries and business types, claims histories associated with job classifications, claims histories associated with individual employees, claims histories associated with combinations of any of the above, such as claims histories associated with job classifications of employers and job classifications at employer facilities. In embodiments, loss control system server 110 may be configured to receive and process data relating to claims history in connection with insurance policies issued by other carriers.

Loss control system server 110 is configured to receive data indicative of an employer 170 decision to receive loss control services. Loss control system server 110 may notify employer 170 via any suitable mode of communication, including via e-mail, text message, message in an employer account area of a group benefits system, or may furnish a notification to an insurance company employee at a workstation. The data indicative of a decision to receive loss control services includes data indicative of the employer, the employer facility location and the identification of the employees whose workstations and procedures are to be evaluated for loss control practices. In response, loss control system server 110 may initiate a process to assign an on-site analyst to perform a loss control evaluation with respect to the identified employees. The assignment of the on-site analyst may include prompting an insurance company employee, such as a manager, for a selection of an on-site analyst.

The loss control system server 110 may be configured to provide to portable user-accessible device 130, for use by an on-site analyst 135, suitable documents, such as template documents 140, to provide instructions and to prompt the on-site analyst for data during and following a workplace review. For example, for a workplace analysis involving workers at computer workstations, web documents, application software, and other forms may be generated to prompt the on-site analyst to provide data relating to a workstation, such as the height and type of chair, the height of desk spaces, available leg room under a desk, a height of a computer monitor, an angle of a computer monitor, a type, height and angle of keyboard, type and location of mouse or other pointing device, location and height of a telephone, and other data. Other types of data would be suitable for review of warehouse, manufacturing and other types of jobs. In general, any type of data that is useful in an ergonomic analysis of a workstation or an employee's use of workstations or equipment may be observed and recorded during a site visit.

In addition to providing an analysis of a workstation, documents generated by portable user-accessible device 130 may prompt the on-site analyst to provide data for generation of a functional job analysis. The user may be prompted for data describing the job requirements, which may entered in free text form or via a menu driven interface. The data to be entered may include data as to requirements for time per shift in sitting and standing positions, walking; requirements for lifting, including maximum weights of objects to be lifted, distances and orientation of lifting, number of times per shift or hour, and other relevant data.

In embodiments, a portable user device may be configured to capture still images and video of the workstations and the activities of the workers. By way of example, a laptop computer or tablet computer may include digital imaging capability. By way of further example, digital camera 132 may be employed by on-site analyst 135.

The data, including text, menu selections, still images and video collected by the on-site analyst is provided by the portable user device to loss control system server 110. The loss control system server 110 stores the worksite visit data in one or more databases, the data being associated with the employer and facility. The loss control system server may then, using the received data and stored rules and procedures, generate reports 180 including recommendations for changes to workstation configuration to reduce the risk of injury and loss and to generate functional job analyses. In embodiments, a human operator may access data and create a report, or a human operator may be presented with a system-generated draft report for review and updating. The report may include data captured during the site visit, and may include recommendations for changes to workstation configurations, additional or different equipment, and other changes. The report 180 may be formatted as a report for paper or electronic printing and presented to the employer via postal mail, e-mail, posting to a website, or other modes, such as by delivery to employer user-accessible device 178 located at employer headquarters 179, for review and implementation by employer management. A web server or a printing and mailing system may server as an employer communications interface configured to receive data relating to a worksite analysis from the loss control hardware server and to provide a report to an employer.

Systems for printing, folding, envelope stuffing and application of postage using automated postage meters may be employed, supplied by Neopost or other vendors.

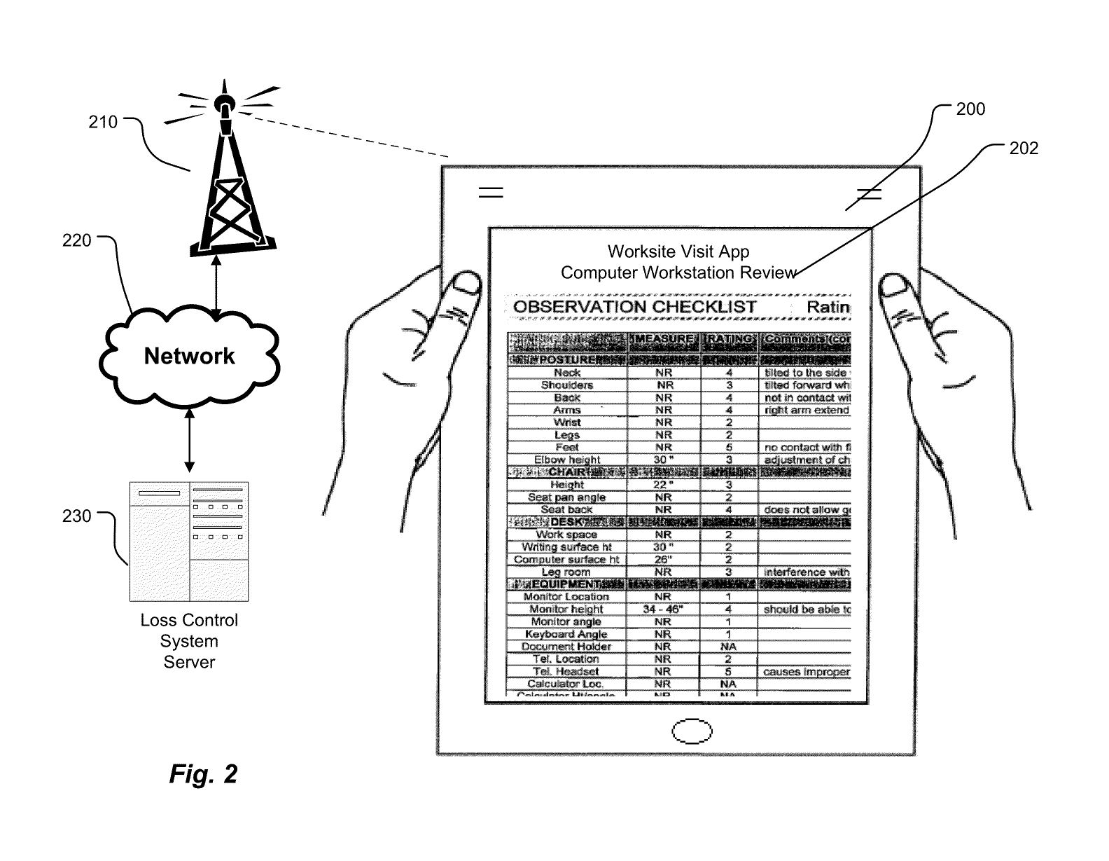

Referring to FIG. 2, an exemplary system of an embodiment of the present invention is shown, showing a screen displayed on a user device. In one embodiment, a user operates a device 200, such as a touch screen type device for viewing and accessing information and data related to their allowance and diversionary accounts as described herein. Touch screen device 200 can be an active sensor employing capacitive, resistive, inductive, or other methods, or it can be a passive surface on which touch sensing is accomplished by optical, acoustic, or other similar methods. Device 200 can also include a liquid crystal display (LCD), organic light emitting diode (OLED) display, electroluminescent display, or any other type of small display suitable for mounting in a portable computer or mobile device. Device 200 may be color or monochrome, and may include a backlight capability to enhance readability in various lighting conditions.

Device 200 may receive web document 202 via wireless connection via wireless network 210, which is in communication via network 220, which may be the Internet, with loss control server 230. Web document 202 displays a portion of a document including prompts for a on-site evaluator to input data relating to observations of office employees operating computer and other communications equipment. In web document 202, examples of the data for which prompts are provided include posture data relating to the neck, shoulders, back, arms, wrists, legs, feet and elbow height. In this example, associated with each item of posture data, the user is prompted to provide a numerical value of a measured quantity, or to indicate, such as by the entry “NR,” that no numerical quantity was recorded. The user is further prompted to provide a numerical qualitative rating of posture for each item, and has the option of providing comments, which may be provided in free form text or by drop down menus with suitable options associated with each item. In general, any data relating to a suitable ergonomic analysis of the workstation may be collected employing web document 202.

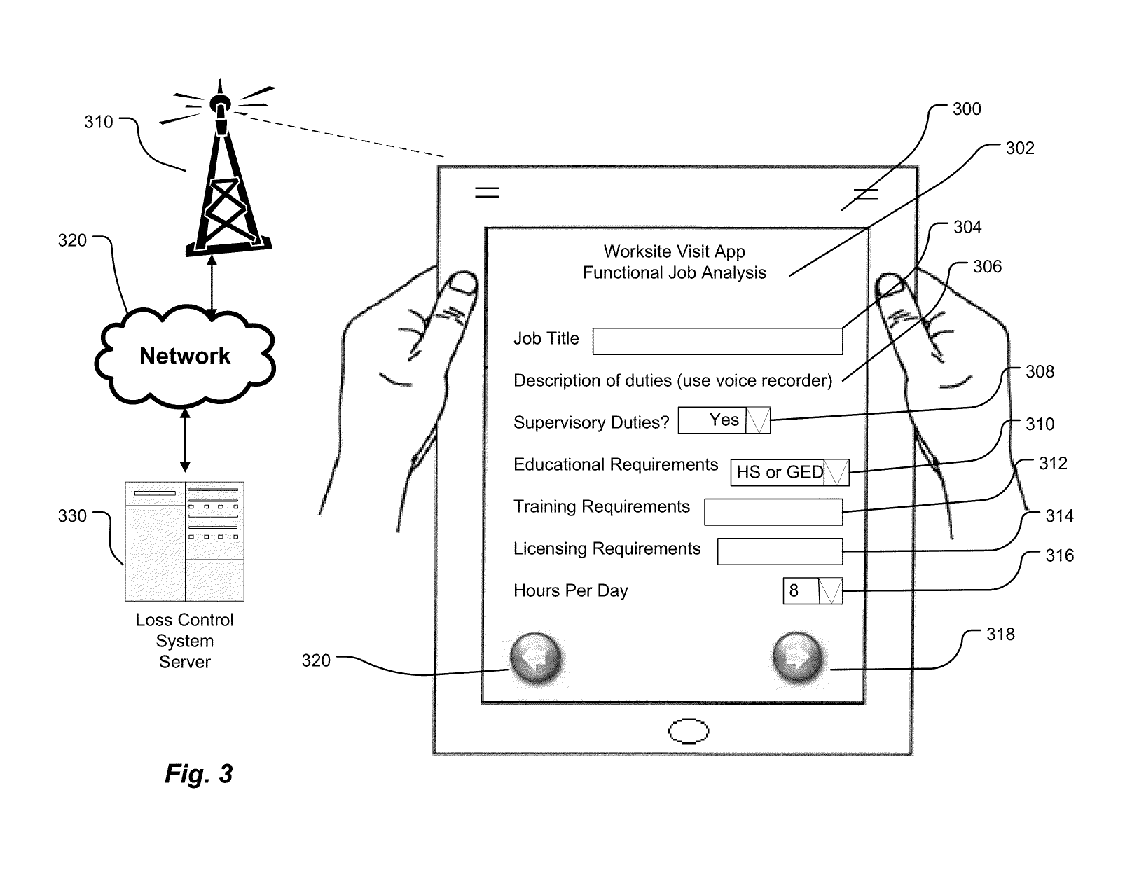

Referring to FIG. 3, an exemplary system of an embodiment of the present invention is shown, displaying a screen displayed on a user device 300. In the embodiment of FIG. 3, user device 300 is a touch screen device including a processor, memory devices and touchscreen display configured for video output and receiving user input via touch sensing. User device 300 is providing a display in accordance with processor executable instructions stored in a non-transitory computer readable medium, such as a local memory device. The instructions may define an application program stored in the memory device of the touch screen device 300. The application program is configured to prompt the user for data related to a job performed at the employer site. As shown in the example, categories of data include job title 304, description of duties 306, supervisory duties 308, educational requirements 310, training requirements 312, licensing requirements 314 and hours per day 316. The user may select a forward button 318 to move to a next screen to input additional data related to the job description, and a back button 320 to move back to a prior screen, such as to review and update if needed data entered on a prior screen.

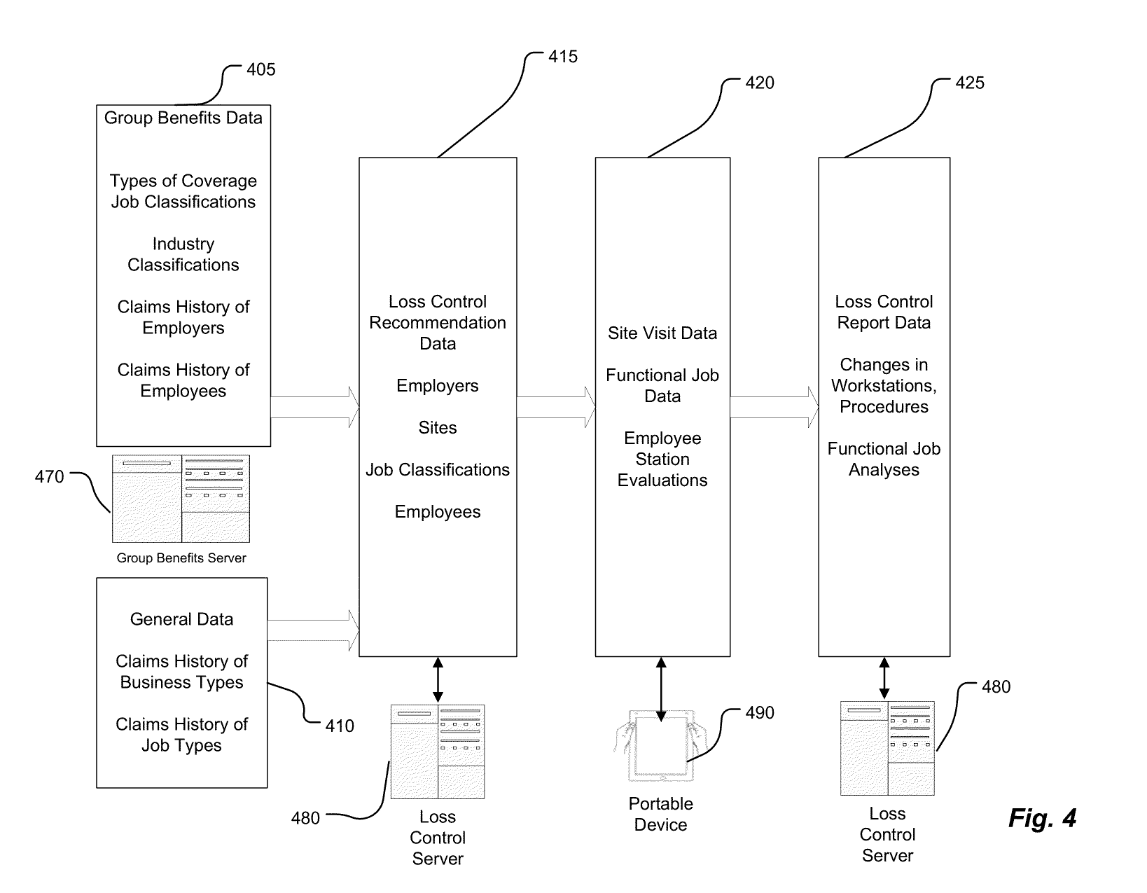

Referring to FIG. 4, a high level diagram showing data flow in an embodiment of a method and system of the invention is provided. Group benefits policy data 405 relates to group benefits policies issued by an insurance company. Group benefits policy data 405 may include data relating to types of coverage, such as short term disability, long term disability, group term life insurance, health insurance; job classifications of covered employees, such as a code under the Standard Occupational Code (SOC) system issued by the U.S. Bureau of Labor Statistics; Industry Classifications, such as Standard Industrial Codes (SIC) codes of customers, claims history of employers, including data such as, for each claim filed with respect to an employer, the date, cost, time off work, SOC code of the employee, location of the employee; claims history associated with employees, such as associations between individual employees and data for claims filed, such as date, cost, time off work, and other data. Group benefits data may be stored and processed by group benefits server 470.

General data 410 may include data not related to particular employers. For example, general data 410 may include data obtained from insurance company records and third party sources relating to general industry claim trends, including data such as statistical data relating to frequency and cost of claims per unit number of employees per time period (e.g., based on standard rate such as per 100 full time equivalent employees per year, or based on a standard such as per 1000 hours worked) by SOC code, geographic location, employer, and other criteria.

Loss control server 480 processes group benefits policy data 405 and general data 410 to determine loss control recommendation data 415. For example, loss control server 480 may compare claims history data of employers relating to SOC codes to comparable general data, and identify, for each employer, SOC codes having claims history, such as by numbers of claims, cost of claims, or duration of claims, per unit number of employees or hours worked per time period, varying from a median or average by more than a threshold. Other processing steps may be taken as well, such as evaluating by facility location, performing the evaluation by groups or classes of occupations or of related SOC codes, such as all production occupations, rather than individual SOC occupations. Other processing steps may include removing codes or groups below a certain minimum threshold, to exclude occupational categories in which the numbers for an employer are too low to be statistically significant.

Loss control server 480 may process data to obtain data 415 indicative of recommendations for employers, sites, job classifications and individual employees recommended for loss control evaluation services. Data as to identified classifications, employers, sites and employees is provided to portable user device 490. Portable user device 490 collects site visit data 420 from a workplace site visit, in structured form, such as data relating to job duties, qualifications and conditions, and details as to workstations and other facilities. Portable user device 490 then provides the collected data to loss control server 480 for processing to develop loss control report data 425, which may include reports such as functional job analyses and reports with recommendations for changes to workplaces for reduction of risk of injury which may result in short term disability claims.

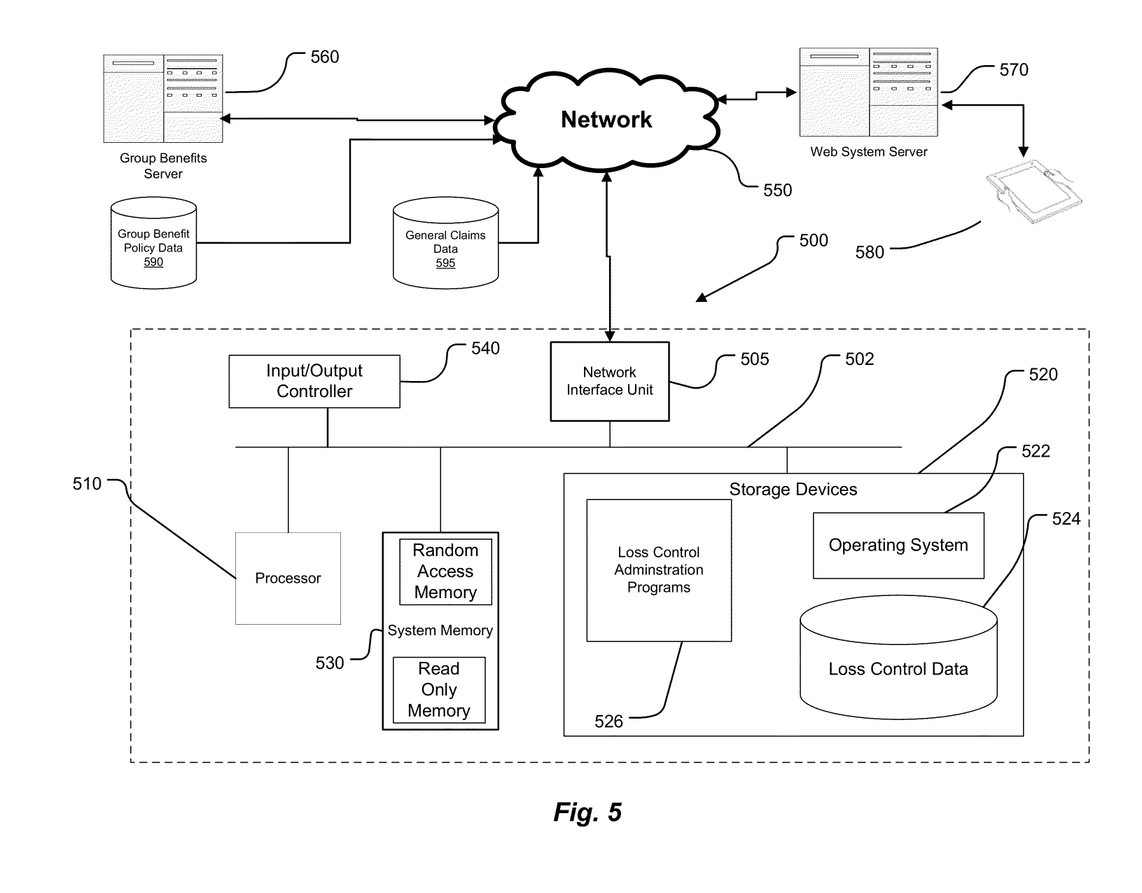

Referring to FIG. 5, an exemplary computer system 500 for use in an implementation of the invention will now be described. In computer system 500, processor 510 executes instructions contained in loss control administration programs 526, which programs are stored in storage devices 520. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine. Application program 526 may include separate modules for such functions as retrieving group benefits data and general claims data, processing group benefits data and general claims data to identify candidates for loss control evaluations; generate inquiries to employer computer systems as to interest in loss control evaluations; furnishing data, web forms and other data to portable user devices to facilitate site evaluations; receiving and analyzing site evaluation data; and generating reports incorporating recommendations based on received and analyzed site evaluation data; furnishing of data to printing and mailing systems, web servers and other systems for client communications; by way of example. Storage devices 520 may include suitable non-transitory computer-readable storage media, such as optical or magnetic disks, fixed disks with magnetic storage (hard drives), flash memory, tapes accessed by tape drives, and other storage media. Processor 510 communicates, such as through bus 502 and/or other data channels, with network interface unit 505, system memory 530, storage devices 520 and input/output controller 540. Via input/output controller 540, processor 510 may receive data from user inputs such as pointing devices (including mice and trackballs), touch screens, audio inputs and keyboards, and may provide data to outputs, such as data to video drivers for formatting on displays, data to print drivers for transmission for printing in hard copy or to image files, and data to audio devices.

Storage devices 520 are configured to exchange data with processor 510, and may store programs containing processor-executable instructions, including instructions for implementing identification of candidates for on-site workplace evaluations, assessment of data collected from on-site evaluations to generate reports regarding workplace adjustments, and other functions. Processor 510 is configured to perform steps in accordance with such processor-executable instructions. Processor 510 is configured to access data from storage devices 520, which may include connecting to storage devices 520 and obtaining data or reading data from the storage devices, or storing new and updated data into the storage devices 520. Storage devices 520 may include local and network accessible mass storage devices. Storage devices 520 may include media for storing operating system 522 and mass storage devices such as loss control data storage device 524 for storing data related to employers, occupational descriptions, claims history, on-site evaluations and recommendations. Such data may include data described in connection with FIG. 4, for example.

Still referring to FIG. 5, in an embodiment, inputs may include user interfaces, including workstations having keyboards, touch screens, pointing devices such as mice and trackballs, or other user input devices, connected via networked communications to processor 510. Network interface unit 505 may communicate via network 550 with other insurance computer systems, such as group benefits administration systems and portable systems for use by on-site evaluators, with third party sources of data, such as sources of data relating to general claims histories, and with employer computer systems, such as to communicate reports and recommendations for workplace safety.

Network interface unit 505 may further communicate with other insurance company computer systems, such as group benefits server 560 and web system server 570. Network interface unit further permits receipt via network 550 of group benefits policy data 590 and general claims data 595 from remote sources. The web system server 570 may generate web documents for display on portable user device 580, including web documents for an on-site evaluator to complete to collect data regarding workplace conditions, job functions, and other data related to on-site evaluations. Web system server 570 may further generate web documents embodying reports having recommendations for workplace safety improvements and the like for display to an employer representative on a portable user device 580 or other portable or fixed device. In embodiments, a user operating portable device 580 may provide data via web system server 570 and network interface unit 505 to system 500. Data may include, from an employer user of portable device 580, authorizations to conduct worksite evaluations, responses to system-generated reminders and requests for status of recommended workplace and job modifications, by way of example. Data from an on-site evaluator who is a user of portable device 580 may include data relating to observations and recommendations relating to job functions and workplace conditions.

Network 550 may be or include wired or wireless local area networks and wide area networks, and over communications between networks, including over the Internet. Any suitable data and communication protocols may be employed.

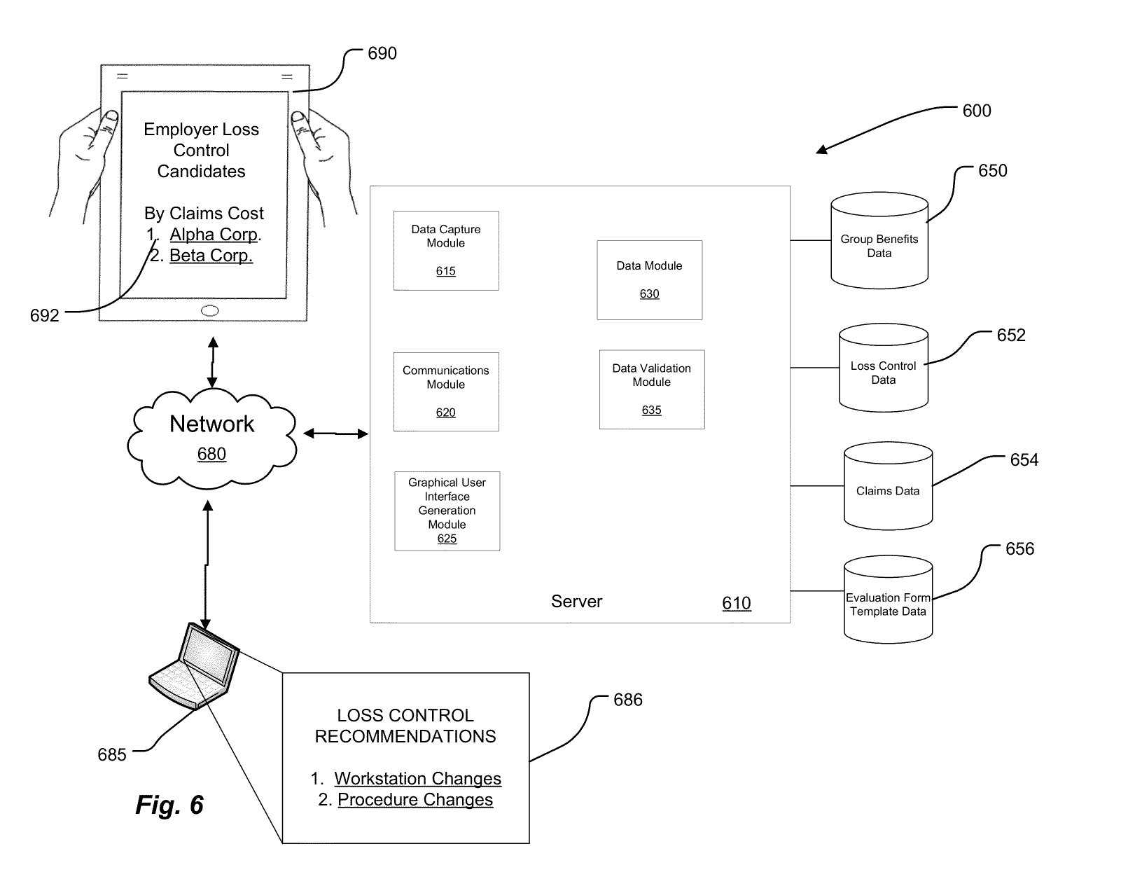

Referring now to FIG. 6, another exemplary embodiment of a system 600 of the present invention is shown. System 600 includes an insurance company hardware server 610 which includes one or more engines or modules which may be utilized to perform one or more steps or functions of embodiments of the present invention. In an embodiment, the present invention is implemented as one or more modules of a computer software program in combination with one or more components of hardware. Such software programs will be used when a system user, such as an insurance company employee or an employer representative, has sent a request for data or information to a server and comprises part of the processing done on the server side of the network. Such software programs may also operate on an automated basis, such as a periodic batch basis to evaluate group benefits insurance customers to identify employers, facilities, occupational groups and other subgroups that would appear to benefit by loss control services. For example, on a rotating basis, each employer in the group benefits database may be evaluated for benefit by loss control services by calculations by the server to determine average and median claims related data, such as number, cost and duration of claims, and comparing such data to comparable data, such as average and median figures for the same occupational group, size of employer, or other comparable data. The programs may be used in an Internet environment, where the server is a Web server and the request is formatted using HTTP (or HTTPS). Alternatively, the server may be in a corporate intranet, and extranet, or any other type of network. Use of the term “Internet” herein, when discussing processing associated with the user's request, includes these other network environments, unless otherwise stated. Additionally, a graphical user interface or other module may be implemented as an intelligent hardware component incorporating circuitry including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of a web client or other module may be implemented as application software in the form of a set of processor-executable instructions stored in a memory of a client device, such as tablet computer 690 or laptop 685, and capable of being accessed and executed by a processor of the client device.

Referring still to FIG. 4, server 610 includes a data capture or input/output module 615, a communications module 620, a dynamic display generation or graphical user interface module 625, a data module 630, and a data validation module 635. Data module 630 is in further communication with a number of databases such as group benefits database 650, loss control database 652, claims database 654 and evaluation form template database 656. Databases 650, 652, 654, 656 may be implemented in one or more physical data storage devices in communication with server 610, or may be implemented in remote data storage devices accessible over one or more networks, such as cloud computer servers accessible via the Internet. Databases in communication with server 610 may include both internal and/or external/third party databases. By way of example, external databases may include databases maintained by government agencies and commercial entities occupational data and claims data. Server 610 may be configured for bulk upload of data, such as bulk upload of claims data relating to an employer. Such data may be furnished such as via a spreadsheet file or via suitable xml documents, by way of example. Data may be exchanged between server 610 and one or more legacy systems via suitable middleware systems. One or more modules, such as data validation module 635, may be configured to perform data validation steps prior to storing bulk uploaded data. Server 610 may further be configured to permit bulk download of data, such as data relating to claims histories of employers, to a device of suitably-authorized user.

In operation, server 610 is in communication with client devices, such as laptop computer 685 or tablet computer 690 via network 680 which facilitates interaction with server 610, such as through web documents, graphical user interfaces and application programs running on client devices 685, 690, as shown and described herein. As used herein, devices, such as client devices 685, 690 may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Referring still to FIG. 6, utilizing client devices 685, 690, a properly authenticated system user, such as an insurance company employee, an on-site evaluator, or a representative of an employer, may access data relating to loss control evaluations, recommendations and compliance, and may furnish data relating to loss control evaluations, recommendations and compliance to server 610 for suitable processing. By way of example, display 686 may be generated and displayed on laptop computer 685 to provide loss control recommendation data to an employer. Display 686 includes links for workstation changes and procedure changes; upon selection, additional text is served to the laptop computer 685 and displayed.

By way of further example, display 692 may be a web document provided to an insurance company employee showing results of an analysis performed by server 610 to determine candidates for loss control services. Display 692 may include links, which, when selected, cause web documents with particular sort orders for identified candidates to be served. The web document may provide a user an option of sending a message to an employer representative, such as via e-mail, text or other communication mode, with a proposal for performance of loss control evaluation services. Data indicative of instructions may be uploaded to server 610, which then may implement the instructions in accordance with processor-executable instructions. Alternatively, server 610 may be configured to generate data indicative of web documents for display on device 690 to verify instructions prior to dispatching communications to employers. Server 610 may further generate data for transmission to device 690 which is displayed by an application program to confirm that the instruction has been received and is being implemented. Server 610 may be configured to confirm such activities in other manners, such as by sending electronic e-mail or text messages, sending instructions for printing and mailing of physical letters to employers, and other suitable methods.

A properly authenticated individual, such as an employee of an insurance company having administrative responsibilities, may access further data and provide updates and modifications to data, such as updates to evaluation form template data stored in database 656 and to implement updates to processing logic employed to identify candidates for loss control evaluations, to administer loss control on-site evaluation procedures, for generation of reports and for follow up activities in response to reports and recommendations. In embodiments of the present invention, one or more of the above modules, may also be implemented in combinations of software and hardware for execution by various types of computer processors coupled to such hardware.

As used herein, a module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, define the module and achieve the stated purpose for the module such as implementing the business rules logic prescribed by the present system. In embodiments of the present invention a module of executable code may be a compilation of many instructions, and may be distributed over two or more different code partitions or segments, among different programs, and across two or more devices. Similarly, data, including by way of example claims data, group benefits data, loss control data and form template data, may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

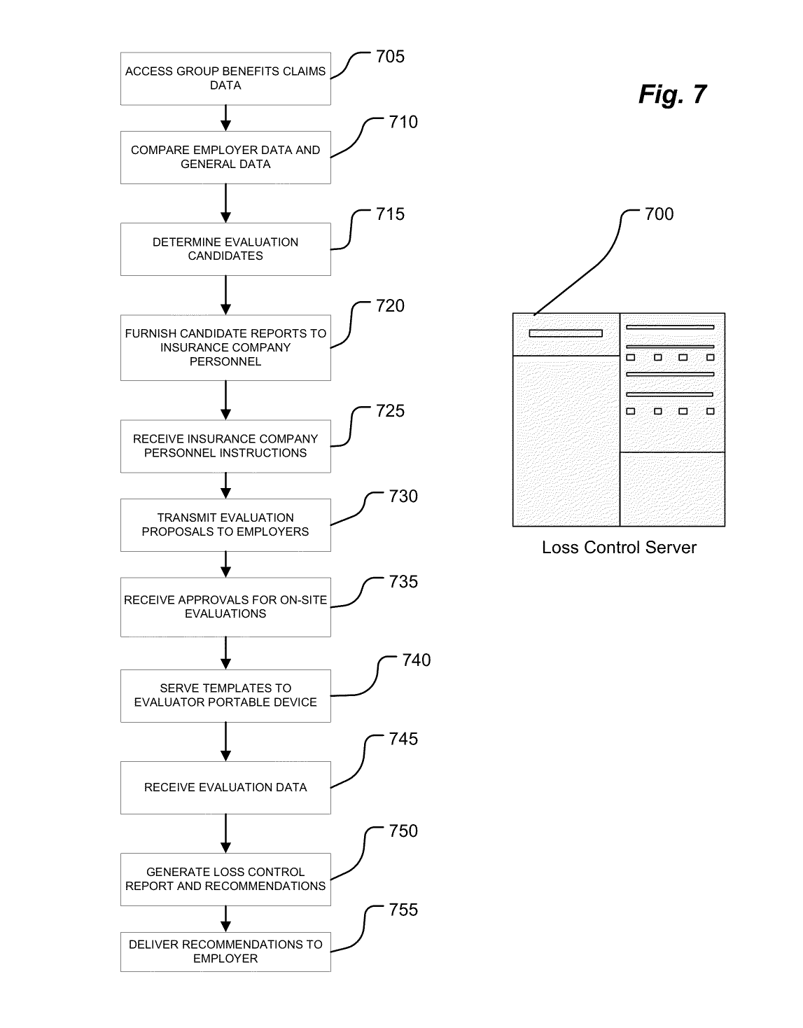

Referring to FIG. 7, a process flow of data processing steps performed by loss control server 700 in an exemplary embodiment, is shown. It will be appreciated that one or more steps performed in the process flow of FIG. 7, and other data processing flows, may be replaced by manually-implemented steps.

Loss control server 700, such as on a batch basis on a suitable cycle, accesses 705 data relating to group benefit insurance claims. In embodiments, loss control server 700 may further access data relating to workers compensation claims associated with employers having both workers compensation coverage and group benefits coverage with the same issuing insurance company. The data relating to workers compensation data may be maintained in a separate database or databases from the group benefits data. Loss control server 700 may include one or more modules configured to access workers compensation data from a workers compensation database, identify employers in the workers compensation database corresponding to employers in the group benefits databases, using matching logic to identify correspondences in employer names, facility addresses, numbers of employees and other employer data in the databases. In embodiments, the loss control and workers compensation systems may be configured to prevent the loss control data system from accessing confidential worker compensation claim data, such as claimant name and other personally identifiable data.

The loss control system may perform analyses on accessed claim data, which may include both group benefits claim data and workers compensation claim data. The analyses may include ranking employers by claims frequency, claims duration, claims cost and other measures. The rankings may be determined for sub groups, such as facilities, job classifications, groups of job classifications, job classifications and groups of job classifications at facilities (e.g., all manufacturing jobs at facilities grouped by state), or other manners. The system may access data indicative of general group benefit claims and workers compensation claims for comparison purposes. In an embodiment, instead of the system accessing general claim data, the system may include threshold data employed for comparison in algorithms.

The system may then determine 715 candidates for evaluation. The candidates may be employers, employer facilities, classes of employees with particular employers, and other employee groups. The candidates for evaluation may be determined as certain number of employee groups for each cycle, or by other criteria. For example, the loss control server may be configured to perform an analysis of claims data on a monthly basis, and to select the employer facilities having a highest number of claims per 100 workers in a given time period, e.g., within a one year time period for which accurate data is available. The system generates reports listing candidates for on-site evaluation and furnishes 720 the candidate reports to insurance company personnel, such as by e-mail or other feed to user devices of account representatives associated in a database with the candidate employers.

The system may accompany the reports with prompts for users to indicate that an employer representative is to be contacted with a proposal to perform evaluation services. For example, the system may generate a web document displaying a proposal to be dispatched to the employer, and prompts, such as interactive links, that a user may select to cause the system to dispatch the proposal to the employer via the selected mode. The web document may permit the user to select one of several modes, such as e-mail, fax or postal mail, to correct contact information or recipient information, and to add personal introductory data.

The system then receives 725 from the insurance company personnel the instructions. The system causes 730 the proposal to be transmitted to the user in accordance with the mode data provided by the user, and to include corrected data, personal introductory data, furnished by the user.

The system may then receive 735 data indicative of approval for on-site services. In an embodiment in which analytic consulting data processing is performed by a separate system, the system may transmit data indicative of the approval and the services requested to the analytic consulting data processing system. The analytic consulting data processing system performs verifications on the request. Responsive to an error being identified in the received request for services, the analytic consulting data processing system may generate a return message to the loss control system. Alternatively, the analytic consulting data processing system may generate a message to a human operator to review the request. In another embodiment, the approval data is furnished to a human operator, such as by the loss control system or otherwise, who furnishes the request data to the analytic consulting data system. Upon receipt of data that passes validation, such as from further communication from the loss control system or from a human operator furnishing data to the analytic consulting data processing system, the analytic consulting data processing system generates a request for assignment of an analyst to the services, which request is furnished to a resource management system. The request may be furnished to the resource management system automatically, or by a human operator.

The resource management system is in communication with data records relating to analysts. The data records may include location, availability, and capability data relating to the analysts. The resource management system may generate a work item based on data in the received request, using associated business logic to select an analyst. In an embodiment, the resource management system may be configured to identify a manager of analysts, such as a manager of an office location, and furnish a message to the manager to select a work control analyst. The manager may then input the selection of the on-site analyst. The selection data may then be furnished, either automatically by the resource management system or manually, to the loss control system.

The on-site analyst may then be provided, such as by a message generated by loss control system on a portable device, with data relating to the employer, the service requested, the claims history or other reasons for generation of the service request. The loss control system may have received, such as via manual input from an insurance company representative, such as an account representative, data or instructions relating to the employer, such as data relating to supervisory personnel to be contacted, particular data relating to facilities, business of the employer, claims, or other data. This data is store by the loss control system in a suitable database and associated with the employer, and is furnished to the on-site analyst by the loss control system. The loss control system may also prompt the on-site analyst to contact insurance company personnel familiar with the employer, such as a group benefits account manager familiar with the employer, for additional information. The loss control system may generate web documents for display on a portable device for entry of data by the on-site analyst, which data may be automatically transmitted by the portable device and stored by the loss control system.

The loss control system may be configured to prompt the user via the portable device to contact the employer to schedule the on-site evaluation, and to provide contact information and data relating to particular employees, areas of offices and plants, equipment and the like needed for the visit.

Referring again to FIG. 7, the loss control system may further be configured to serve 740 to the portable device suitable templates for entry of data. The templates may be stored in a database accessible to the loss control system server and may include templates to provide data suitable for workstations assessments for one or more types of workstations or jobs; functional job analysis; return to work analysis; and training for loss control trainers.

Templates suitable for use by an on-site analyst on a portable user-accessible device may be provided in a variety of forms, including as fillable documents, such as document 202 of FIG. 2, or as a web document 302 of FIG. 3. The templates may be provided as application software that may be transmitted to the portable device and installed as a stored computer-readable instructions in a non-transitory memory storage device of the portable device, for example. The templates associated with one or more of these functions may be pre-filled with data on an automated basis prior to the site visit. For example, employer name and address and employee data may be pre-populated in the templates by the loss control system. For templates related to return to work analyses, data relating to employee capabilities prior to complete recovery, such as limits on weights that can be lifted, hours per day, continuous hours or other data, may be included in templates.

The loss control server then receives 745 worksite evaluation data input at the user-accessible device. The data may be received after serving of all templates. Alternatively, the loss control server may receive data, such as data responsive to a web document, perform verification, and only serve a next web document responsive to verification of completion of all fields in the web document.

The loss control server then generates 750 a loss control report and recommendations. The generation of the loss control report and recommendations may be based on business logic embodied in computer-readable program code, for example. The business logic may include rules for determination of improved workstation equipment. For example, for an office environment, the business logic may include a rules that provides that, for received worksite data indicative of a standard keyboard, the recommendation data in the report is to include an ergonomic keyboard. Other examples may include business logic relating to height of desks and equipment, maximum weight of items to be lifted, by way of example. In an embodiment, the loss control server may include business logic to select a particular type of workstation, such as an office workstation, or a workstation associated with a particular industry, and then business logic associated with the selected type of workstation. The report and recommendations may include recommendations for workstation modifications. In an embodiment, business logic associated with an office environment may include rules providing for substituted equipment, such as ergonomic keyboards and pointing devices, improved chairs, modified lighting, modified placement of equipment, and other rules.

In an embodiment in which a functional job analysis is being generated, the business logic may include reviewing the submitted data for inconsistencies, such as a total of more than 8 hours per day standing, sitting and walking. The business logic may be configured on an industry-by-industry basis, or by job descriptions, for example, to identify discrepancies to be flagged by a reviewer. For example, discrepancies may include an indication of use of unusual equipment for a job description, such as a fork lift for a clerical position.

In an embodiment in which return to work recommendation data is being generated, the business logic may include suggestions for transitional duties based on prior return to work recommendations in a database accessible to the server.

A report may be generated using the business logic and presented to an evaluator in draft form for review and updating. The system may be configured to prompt an evaluator for approval, at which time a report may be delivered 755 to the employer.

The system may be configured to set flags after delivery of a report for follow up contact with the employer to determine whether recommended actions have been taken. The flags may include a date or time period after delivery of a report for contact to be generated in an automated manner directly to an employer, or a reminder to an insurance company employee to contact the employer, by way of examples.

The system may further be configured to access claims data subsequent to submission of a report and recommendations, to analyze claims data for rates relating to claims, and to generate comparative reports. By way of example, a period of one year or more after a recommendation may result in such a further analysis of claims data. A report may be generated with comparative data to indicate changes in rates associated with claims as a result of implementation of recommendations. In embodiments, a loss control system server may be configured to access data indicative of group benefits claims history prior to implementation of loss control recommendations and data indicative of group benefits claims history following implementation of loss control recommendations, and to compare the data to determine improved claims performance following implementation of loss control recommendations. Reports may be generated by the server and furnished to the employer having data indicative of improved claims performance, such as reductions in numbers of claims per unit time, cost of claims per unit time, duration of claims (e.g., of disability) per unit time, and other data.

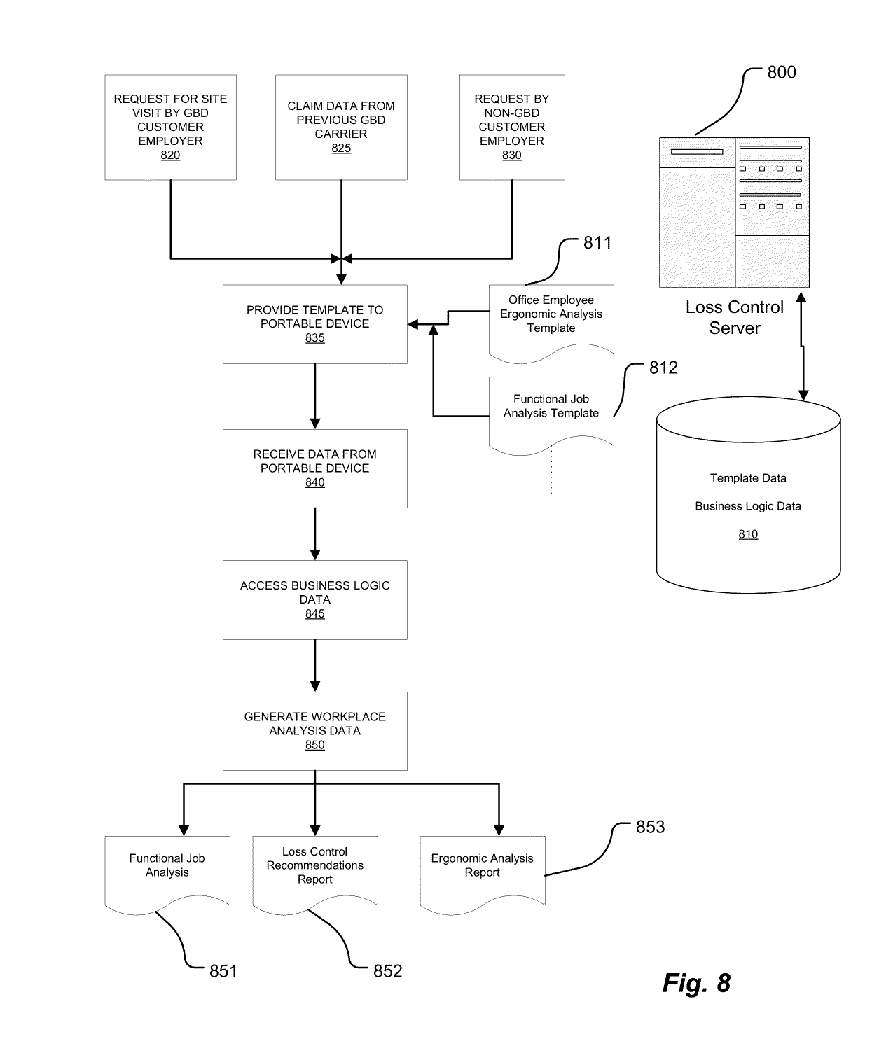

Referring to FIG. 8, a process flow of an alternate embodiment of a method of the invention is illustrated. The process flow of FIG. 8 illustrates steps that may be performed by loss control hardware server 800 in communication with data storage device 810. A process flow may commence with a request for a site visit by a group benefits insurance customer 820, by furnishing claims data from experience with one or more prior group benefits carriers 825 for analysis by the loss control hardware server 800, or by a request from an employer that is not a group benefits customer 835, such as a prospective customer by way of non-limiting example. The system may determine, based on data received relating to the request, a suitable template to provide to a portable device for use by an on-site analyst, which template may be furnished 835 to the portable device. Data storage device 810 may store templates, including exemplary office ergonomic analysis template 811 and functional job analysis template 812. In embodiments, the templates may be provided in any suitable manner, including as static documents, web documents and in other manners.

After the suitable templates have been served, the on-site analyst collects worksite data, and then the worksite data is received 840 by the system. The system accesses 845 business logic data from data storage device 810 to analyze the received data. Suitable business logic data may be selected depending on the type of analysis, such as a loss control evaluation, a functional job analysis, an ergonomic analysis or other type of analysis. The business logic data may further be selected depending on an occupational category associated with the worksite, or a class or group of occupational categories, such as SOC codes. The business logic data may further be selected based on industries, business types, SIC (Standard Industrial Classification) codes and other types of classifications of businesses and industries.

The system then generates workplace analysis data 850. The workplace analysis data may include workplace loss control recommendation data, functional job analysis data and ergonomic analysis data, by way of example. Workplace loss control recommendation data may include recommendations for changes or modifications to equipment, practices and procedures and other recommendations. Functional job analysis data may include detailed job analysis data including qualifications, duties, breakdowns of daily duties into specific tasks, and the like. Ergonomic analysis data, which may be included in workplace loss control recommendation data, may include recommendations for modifications to equipment such as chairs, desks, keyboards, phones, pointing devices and their locations, by way of example. The workplace analysis data may be formatted as a suitable paper, electronic static or interactive document to be provided to the employer. Exemplary documents include functional job analysis report 851, loss control recommendations report 852 and ergonomic analysis report 853. These are merely exemplary types of documents, and other types of documents, such as transitional duties recommendations and other types of reports and documents may be generated.

Throughout processing steps, accessed values, calculated values and draft data, for example, may be stored in temporary memory locations, such as in RAM.

A processor may provide the central processing unit (CPU) functions of a computing device on one or more integrated circuits. The term “processor” may include multi-core processors and central processing units including multiple microprocessors. The central processing unit functionality may be provided at one or more remote locations, such as through application service provider and cloud computing services.

In embodiments, a processor may provide an output signal having data indicative of one or more data items. An output signal may be carried either over a suitable medium, such as wire or fiber, or wirelessly. An output signal may transmit data from one device to another directly, such as over a bus of a computer system from a processor to a memory device, or indirectly, such as over multiple networks, and with intermediate steps of storage in a buffer or memory device and retransmission. Such an output signal may be provided by the processor to a bus of a computer system together with address data at a series of clock intervals. The address data may designate a destination device on a bus, by way of example. In embodiments, an output signal may be a signal output from a hardware communications device of a computer system to a network, such as a local area network, a wide area network, or a network of interconnected networks, such as the Internet. Output signals may include, by way of example, data identifying formats, fields, and content of fields. Signals may be compatible with any appropriate format. For example, data may be formatted in accordance with a data format for insurance data, such as an ACORD compatible format, or a non-ACORD xml format. Reference to an output signal having particular data may include one or more signals bearing the information. Multiple signals bearing the information may include sequences of digital data bearing the information interleaved with sequences of digital data relating to other information. By way of example, a signal may be packetized for transmission. By way of further example, an output signal may take the form of an uncompressed digital signal or a compressed digital signal.

A system on which the methods of embodiments of the present invention may be implemented includes at least one central processing computer or computer network server. A network server includes at least one controller or central processing unit (CPU or processor), at least one communication port or hub, at least one random access memory (RAM), at least one read-only memory (ROM) and one or more databases or data storage devices. All of these later elements are in communication with the CPU to facilitate the operation of the network server. The network server may be configured in many different ways. For example, a network server may be a standalone server computer or alternatively, the functions of a network server may be distributed across multiple computing systems and architectures.

A network server may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP.

Data storage device may include hard magnetic disk drives, optical storage units, CD-ROM drives, or flash memory, by way of example. Data storage devices contain databases used in processing calculations embodied in algorithms, including data for display on client devices and data for determination of rates of claims, cost of claims and duration of claims; comparisons of rates to general industry rates, and other calculations. In one embodiment, database software creates and manages these databases. Loss control calculations and algorithms in accordance with an embodiment of the present invention may be stored in storage devices and accessed and executed by a processor, in accordance with instructions stored in compute-readable storage media. Such algorithms may be embodied in modules of program code, or located in separate storage locations and identified in program code by pointers, by way of example.

Suitable computer program code may be provided for performing numerous functions such as identifying group benefits insurance customers that are candidates for loss control services, correlating customers for other types of insurance such as workers compensation coverage with customers for group benefits insurance, generating documents and instructions for use by on-site evaluators, analyzing data from worksite reviews, generating reports and recommendations, and prompting insurance company personnel and employer personnel for follow up related to recommendations for changes in workplace equipment or practices. The functions described above are merely exemplary and should not be considered exhaustive of the type of function which may be performed by the computer program code of embodiments of the present inventions.

The computer program code required to implement the above functions (and the other functions described herein) can be developed by a person of ordinary skill in the art, and is not described in detail herein.

The loss control server described herein may be in communication with systems including group benefits administration systems, printing and mailing systems, personnel administration systems, workers compensation insurance administration systems, and group benefits premiums administration systems.

The term “computer-readable medium” as used herein refers to any medium that provides or participates in providing instructions to the processor of the computing device (or any other processor of a device described herein) for execution. Such a medium may take many forms, including but not limited to, non-volatile media, non-transitory media, tangible media, volatile media, and transmission media. Non-volatile media and tangible media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Servers of embodiments of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc).

An exemplary advantage of a method and system of the present invention is that an employer that provides group benefits coverage may receive via an insurance company recommendations for practices that may decrease number, duration and/or cost of future group benefits claims.

While particular embodiments of the invention have been illustrated and described, various modifications and combinations can be made without departing from the spirit and scope of the invention, and all such modifications, combinations, and equivalents are intended to be covered and claimed.

What is claimed is:

1. A computer system for processing data related to loss control associated with worksites, comprising:
a loss control hardware server, configured to:
receive data indicative of worksite conditions from a portable user-accessible device;
access from a data storage device stored business logic data relating to worksite condition analysis; and
and process the data indicative of worksite conditions in accordance with the accessed business logic data to generate workplace analysis data relating to the worksite of the employer; and
an employer communications interface device configured to receive the workplace analysis data from the loss control hardware server and generate an employer communication incorporating the workplace analysis data.

2. The computer system of claim 1, wherein the loss control hardware server is further configured to generate a functional job analysis, and the workplace analysis data comprises functional job analysis data.

3. The computer system of claim 1, wherein the loss control hardware server is further configured to generate workplace loss control recommendations, and the workplace analysis data comprises workplace loss control recommendation data.

4. The computer system of claim 1, further comprising:
a group benefits insurance data storage device, in communication with the loss control hardware server, storing data relating to employee group benefits insurance issued by an insurance company to a plurality of employers, the data including identifications of employers, coverage under the employee group benefits insurance, and claims under the employee group benefits insurance; and
wherein the loss control hardware server is further configured to access the data stored in the group benefits insurance data storage device and determine based on the accessed data from the group benefits insurance data storage device one or more employers selected for notification of availability of loss control services.

5. The computer system of claim 4, wherein the loss control hardware server is configured to determine the one or more employers selected for notification of availability of loss control services based on comparing at least one of rates of numbers of claims, cost of claims, and duration of claims, in one or more occupational categories, to general rates of numbers of claims, cost of claims, and duration of claims, in the one or more occupational categories.

6. The computer system of claim 1, wherein the employer communications interface comprises a report printing and mailing system configured to format, print and mail reports incorporating the workplace analysis data.

7. The computer system of claim 1, further comprising a web server in communication with the loss control hardware server and configured to serve web documents to a portable user-accessible device to prompt a user for selection of worksite condition observations.

8. The computer system of claim 7, wherein the web server is further configured to serve web documents to an employer user-accessible device for communication of workplace analysis data.

9. The computer system of claim 1, wherein the workplace analysis data comprises workplace loss control recommendation data including data indicative of recommendations for one or more of changes to workstation configuration, additional equipment, changes to process steps and changes in job duties.

10. The computer system of claim 1, wherein the loss control hardware server is further configured to provide data to a portable device to cause the portable device to display one or more documents to prompt a user of the portable device to input data for generation of a functional job analysis.

11. The computer system of claim 1, wherein the loss control hardware server is further configured to provide data to a portable device to display one or more documents to prompt a user of the portable device to input data for generation of return to work recommendations.

12. A computer-implemented method for processing data relating to loss control associated with worksite conditions at locations of employers, comprising:
receiving, at a loss control system hardware server, from a portable user-accessible device, data indicative of worksite conditions at a worksite of one of the employers;
accessing, by the loss control system hardware server, from a data storage device, stored business logic data relating to worksite condition analysis processing, by the loss control hardware server, the data indicative of worksite conditions in accordance with the accessed business logic data, to generate workplace analysis data relating to the worksite of the employer;
receiving by an employer communications interface device the generated workplace analysis data; and
generating by the employer communications interface device an employer communication incorporating the workplace analysis data.

13. The computer-implemented method of claim 12, further comprising:
storing by a group benefits insurance data storage device data relating to employee group benefits insurance issued to the employers, the data including identifications of employers, coverage under the employee group benefits insurance, and claims under the employee group benefits insurance;
accessing by the loss control hardware server the stored data relating to group benefits claims; and
determining by the loss control hardware server based on the accessed group benefits claims data one or more employers selected for notification of availability of loss control services.

14. The computer-implemented method of claim 13, wherein the determining further comprises accessing by the loss control hardware server data relating to workers compensation claims of one or more of the employers, and determining the one or more employers selected for notification of availability of loss control services based further on the accessed workers compensation claims data.

15. The computer-implemented method of claim 12, further comprising accessing data indicative of one or more reports of improved group benefits claims history responsive to use of loss control services, and generating by the employer communications interface device an employer communication incorporating the one or more reports.

16. The computer-implemented method of claim 12, wherein the stored business logic data includes business logic for selection of one of a plurality of classes of occupations, and stored business logic data relating to each of the classes of occupations.

17. A non-transitory computer-readable storage medium, the computer-readable storage medium having processor-executable instructions stored thereon relating to processing of data for worksite analysis, which instructions, when executed by the processor, cause the processor to:
receive, from a portable user-accessible device, data indicative of worksite conditions at worksite of an employer;
process the data indicative of worksite conditions in accordance with stored business logic data, to generate worksite analysis data relating to the worksite of the employer; and
output the worksite analysis data to an employer communications interface device.

18. The non-transitory computer-readable storage medium of claim 17, wherein the instructions further cause the processor to:
access data stored in a group benefits insurance data storage device relating to claims under employee group benefits insurance; and
determine, based on the accessed claims data, one or more employers selected for notification of availability of loss control services.

19. The non-transitory computer-readable medium of claim 17, wherein the stored business logic includes business logic for selection of one of a plurality of industries, and stored business logic data relating to each of the industries.

20. The non-transitory computer-readable medium of claim 19, wherein the worksite analysis data comprises loss control recommendation data, and the instructions further cause the processor to set one or more flags for follow up with respect to the loss control recommendation data.
